(19) United States
(12) Patent Application Publication
(10) Pub. No.: US 2013/0110827 A1
(43) Pub. Date: May 2, 2013

(54) RELEVANCE OF NAME AND OTHER SEARCH QUERIES WITH SOCIAL NETWORK FEATURE

(71) Applicants: SHUBHA NABAR, PALO ALTO, CA (US); RAJESH KRISHNA SHENOY, SAN JOSE, CA (US)

(72) Inventors: SHUBHA NABAR, PALO ALTO, CA (US); RAJESH KRISHNA SHENOY, SAN JOSE, CA (US)

(73) Assignee: MICROSOFT CORPORATION, REDMOND, WA (US)

(21) Appl. No.: 13/282,025

(22) Filed: Oct. 26, 2011

(51) Int. Cl. G06F 17/30

(52) U.S. Cl. 707/728; 707/748; 707/E17.002; 707/E17.009; 707/E17.014

(57) ABSTRACT

Systems, computer-readable media, and methods for utilizing information pertaining to one or more individuals or entities with which a user has at least one social networking relationship are provided. A search engine is configured to receive a query, to identify matching electronic documents, to rank the electronic documents, and to transmit the matching electronic documents and/or advertisements to the user in response to receiving a query. Upon receiving the query from a user, the search engine obtains a social network identifier of the user and utilizes information about the user's social networking relationships to augment the query with nonretrieval modifiers. The search engine processes the nonretrieval modifiers matching the electronic documents included in search results and ranks the results but does not use the nonretrieval modifiers to identify or retrieve results matching the query. The ranked electronic documents are included in the results and displayed in rank order to the user.

### BACKGROUND

Conventional search engines provide users with access to a vast amount of information, typically located on the Internet. The Internet consists of billions of content items, including web pages and other multimedia content interconnected by hypertext links, which allow users to navigate among the web pages. Upon entering a search query into the conventional search engines, a user receives a search engine results page having a large number of ranked web pages or other multimedia matching the search query.

Due to the large scale of the Internet and the unique nature of the interlinked web pages, conventional search engines employ complex ranking functions, which examine the connectivity of a web page, such as the number of pages linking to it, in determining a ranking of a web page or other multimedia content included in a search engine results page.

For instance, a conventional search engine may execute a ranking function to order web pages or multimedia based on how well the web pages match the search terms of the search query. Other algorithms that the conventional search engines utilize may compute a measure of the match to the search terms based on the number of other web pages linked to the web page identified for inclusion in the search engine results page.

These ranking functions executed by the search engine do not always prioritize results that the user is interested in. The search engine may be unable to appropriately order or locate relevant results because existing indices may not capture the precise verbiage of the search query.

### SUMMARY

Embodiments of the invention relate to systems and methods for utilizing social network information pertaining to one or more individuals or entities with which the user has at least one predefined type of relationship to present relevant search results and/or advertisements to a user in response to receiving a search query. The search engine utilizes the social network information to modify the query with nonretrieval modifiers that impact the rank of the URLs selected by the search engine but do not impact the selection of URLs retrieved by the search engine. In turn, the search engine transmits the ranked URLs in a search engine results page.

In some embodiments, when the social network information of the user is unavailable, the search engine determines whether the query is classified as a name or person search query. If the search query is classified as a name or person search query, the search engine accesses an index having index entries for web pages or multimedia tagged with social network identifiers of entities associated with the web pages or multimedia. The search query is processed by the index and matching results are returned in a search engine results page for display to the user. In one embodiment, the web pages or multimedia are clustered based on the social network identifiers associated with the matching index entries

Embodiments of the invention are defined by the claims below, not this Summary. A high-level overview of various aspects of embodiments of the invention are provided here for that reason, to provide an overview of the disclosure, and to introduce a selection of concepts that are further described below. This Summary is not intended to identify key features or essential features of the claimed subject matter, nor is it intended to be used in isolation to determine the scope of the claimed subject matter.

### BRIEF DESCRIPTION OF THE SEVERAL VIEWS OF THE DRAWINGS

Illustrative embodiments of the invention are described in detail below with reference to the attached drawing figures, which are incorporated by reference in the their entirety and wherein:

FIG. 1 is a network diagram that illustrates an exemplary computing system in accordance with embodiments of the invention;

FIG. 2 is a logic diagram illustrating an exemplary computer-implemented method for ranking electronic documents provided in a search engine results page, in accordance with embodiments of the invention;

FIG. 3 is a logic diagram illustrating a another exemplary method for ranking electronic documents provided in a search engine results page, in accordance with embodiments of the invention; and

FIG. 4 is a component diagram illustrating an exemplary operating environment, in accordance with embodiments of the invention.

### DETAILED DESCRIPTION

The subject matter of this patent is described with specificity herein to meet statutory requirements. However, the description itself is not intended to necessarily limit the scope of claims. Rather, the claimed subject matter might be embodied in other ways to include different steps or combinations of steps similar to the ones described in this document, in conjunction with other present or future technologies. Although the terms “step”, “block”, and/or “component” etc. might be used herein to connote different components of methods or systems employed, the terms should not be interpreted as implying any particular order among or between various steps herein disclosed unless and except when the order of individual steps is explicitly described.

Various aspects of the technology described herein are generally directed to computer systems, computer-implemented methods, and computer-readable storage media for, among other things, returning relevant URLs in a search engine results page when responding to a query. The URLs may be located based on available social networking data and the search terms included in the query. Embodiments of the invention allow search engines to improve the relevance of search results prioritized for display to the user in response to a query by harnessing profile data from social networks, like Facebook® and Linkedin®.

In some embodiments, the search engine receives a searcher's social network identity and the query of the searcher. The search engine utilizes the social network identifier of the searcher to obtain the social network of the searcher as authorized by the searcher. The social network includes information about the searcher, friends of the searcher, and friends of friends. The search engine utilizes the social network information to rewrite the query. The query is augmented with additional terms obtained from the social network information of the searcher and his friends. These additional terms are nonretrieval terms and affect only the ranking of the retrieved documents, without affecting retrieval itself, i.e., they are disregarded during the retrieval phase, but documents that match the nonretrieval terms may be given a better rank by the search engine than the normal ranks assigned by the search engine.

Embodiments of the invention may be useful when the user provides ambiguous name queries to the search engine. The ambiguous name queries might refer to two or more real-world entities that share the same name and have web presences. The search engine may utilize the social network information of the searcher to determine which of the two or more real-world entities the searcher is more likely interested in. In one embodiment, the search engine selects the entities that are included in the social network of the user.

In other embodiments of the invention, the search engine may not have access to the searcher's social network identifiers. The search engine may receive a query and determine whether the query is classified as a name query. If the query is a name query, the search engine accesses an index of web pages and multimedia having social network identifiers for a plurality of entities. The search engine selects index entries that match the query received from the searcher. In turn, the search engine clusters the matching index entries based on the social network identifier associated with the index entries. The clusters and the results are transmitted to the searcher for display on a computing device. Accordingly, the search engine may improve the searcher's experience when dealing with ambiguous name queries by clustering electronic documents based on social network profile data and presenting the clusters as alternative result sets.

As one skilled in the art will appreciate, the computer system may include hardware, software, or a combination of hardware and software. The hardware includes processors and memories configured to execute instructions stored in the memories. In one embodiment, the memories include computer-readable media that store a computer-program product having computer-useable instructions for a computer-implemented method. Computer-readable media include both volatile and nonvolatile media, removable and nonremovable media, and media readable by a database, a switch, and various other network devices. Network switches, routers, and related components are conventional in nature, as are means of communicating with the same. By way of example, and not limitation, computer-readable media comprise computer-storage media and communications media. Computer-storage media, or machine-readable media, include media implemented in any method or technology for storing information. Examples of stored information include computer-useable instructions, data structures, program modules, and other data representations. Computer-storage media include, but are not limited to, random access memory (RAM), read only memory (ROM), electrically erasable programmable read only memory (EEPROM), flash memory or other memory technology, compact-disc read only memory (CD-ROM), digital versatile discs (DVD), holographic media or other optical disc storage, magnetic cassettes, magnetic tape, magnetic disk storage, and other magnetic storage devices. These memory technologies can store data momentarily, temporarily, or permanently.

In yet another embodiment, the computer system includes a communication network having an index, social network providers, client computers, and a search engine. The index is configured to store URLs for content located on the Internet. A user may generate a query at the computer, which is communicatively connected to the search engine. In turn, the computer may transmit the query and social network identifier of the user—if available—to the search engine. The search engine may use the query to locate URLs, in the index, having content that matches the query. The search engine may provide the URLs in a search engine results page, which may order the results based on the match to the query and nonretrieval modifiers of the user's social network.

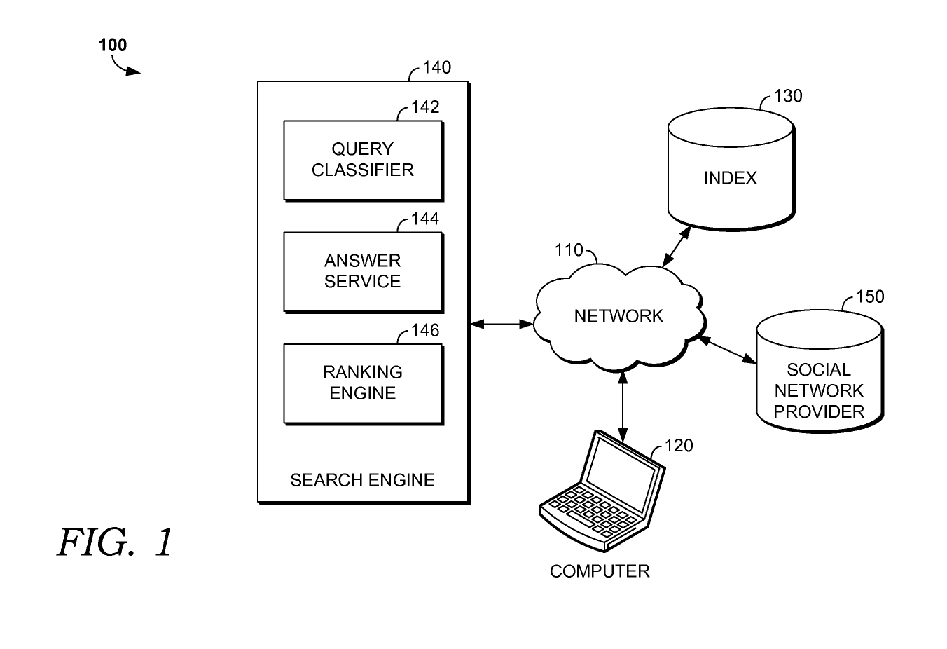

FIG. 1 is a network diagram that illustrates an exemplary computing system 100 in accordance with embodiments of the invention. The computing system 100 shown in FIG. 1 is merely exemplary and is not intended to suggest any limitation as to scope or functionality. Embodiments of the invention are operable with numerous other configurations. With reference to FIG. 1, the computing system 100 includes a network 110, computer 120, index 130, search engine 140, and social network provider 150.

The network 110 enables communication among the various network devices and resources. The network 110 connects computer 120 and search engine 140. The social network provider 150 and index 130 are also connected to network 110. The network 110 is configured to facilitate communication between the computer 120 and the search engine 140. It also enables the search engine 140 to access the social network provider 150 to exchange information based on URLs in a search engine results page and a social network identifier. In some embodiments, the social network identifier is associated with the user. The network 110 may be a communication network, such as a wireless network, local area network, wired network, or the Internet. In an embodiment, the computer 120 interacts with the search engine 140 utilizing the network 110. For instance, a user of the computer 120 may generate a query, like a name query. In response, the search engine 140 interrogates the index 130 for URLs that include web pages, images, videos, or other electronic documents that match the query generated by the user.

The computer 120 allows the user to view a search engine results page received from the search engine 140. In some embodiments, the search engine results page includes clusters for results based on social network identifiers. The computer 120 is connected to the search engine 140 via network 110. The computer 120 is utilized by a user to generate search terms, to hover over objects, to select links or objects, and to receive search engine results pages or web pages that are relevant to the search terms, the selected links, or the selected objects. The computer 120 includes, without limitation, personal digital assistants, smart phones, laptops, personal computers, gaming systems, set-top boxes, or any other suitable client computing device. The computer 120 includes user and system information storage to store user and system information on the computer 120. The user information may include search histories, cookies, and passwords. The system information may include Internet Protocol addresses, cached web pages, and system utilization. The computer 120 communicates with the search engine 140 to receive the search results or web pages that are relevant to the search terms, the selected links, or the selected objects. The computer 120 may communicate with the social network provider 150 to receive social network alerts or a social network graph having profiles associated with the searcher or entities having social network identifiers that match the query, when the query is classified as a name query.

For instance, a searcher may utilize computer 120 to generate a query for “cricket.” The searcher may submit the query to the search engine 140, which may classify the query as a sports query or an animal query. In one embodiment, the search engine may utilize the social network profile data for the user to determine that the user likes a cricket team from England. Thus, the search engine 140 may classify the query as a sports query based on the social network information of the user. In turn, the search engine may augment the query with profile data of the user. For instance, the social network profile data may indicate that the user is from Jamaica but currently lives in England. The search engine 140 may utilize the hometown and current location included in the profile data as nonretrieval modifiers. The search engine 140 may rewrite the query as “cricket Ω (Australia, 100) Ω (England, 50),” where the Ω operator identifies nonretrieval modifiers and the profile attributes and weights are included as variables of the Ω operator. Accordingly, the URLs received from the index 130 that are associated with documents about “cricket” will be ranked based on the match to query and the nonretrieval modifier. So, index entries that match either “Australia” or “England” in addition to “cricket,” are prioritized for display in the search engine results page over index entries that match only “cricket.”

The index 130 stores words and a posting list. The words are typically associated with electronic documents like, web pages, videos, text files, and images. The posting list allows the user to identify the documents associated with the words. In some embodiments, the index 130 also stores tags that correspond to social network identifiers for a plurality of entities on a social network. The tags may be automatically included in the index based on an analysis of the content associated with URLs in each index entry when a match is found between the social network identifier represented by the tag and the content. The tags may be utilized by the search engine 140 when responding to queries, like name queries, for URLs associated with an entity identified in the query.

The search engine 140 is utilized to traverse the index 130 and generate a search engine results page in response to a search request, including name queries. The search engine 140 is communicatively connected via network 110 to the computers 120. The search engine 140 is also connected to index 130 and the social network provider 150. In certain embodiments, the search engine 140 is a server device that generates graphical user interfaces for display on the computer 120. The search engine 140 receives, over network 110, selections of words or selections of links from computer 120 that renders the interfaces that receive interactions from users.

In some embodiments, the search engine 140 includes a query classifier 142, an answer service 144, and a ranking engine 146. The query classifier 142 attempts to classify the query based on the search terms included in the query and social network data associated with a social network identifier of the user if one is available. The query may be classified in one or more categories: like, name, food, restaurant, nature, finance, business, etc. For instance, in one embodiment a query log may be analyzed by the query classifier 142 to determine the click frequency of one or more documents included in a prior search for the query. In turn, the documents with the highest click frequency may be selected as representative documents and analyzed to determine the classification of the documents. For instance, if the query was “cricket” and the query classifier's 142 analysis of prior results shows that most of the clicked prior results were about sport teams and not bugs or insects, the query classifier 142 may select the sport classification as the primary classification and the animal classification as a secondary classification. In another embodiment, the social network data of the user may be received and likes of the user may be analyzed by query classifier 142 to determine whether the content likes are about sport teams or bugs and insects. If the majority of the likes are about bugs and insects instead of sport teams, query classifier 142 may select the animal classification as the primary classification for the query. In yet another embodiment, a one-word query, such as “bass,” may be classified by the query classifier 142 into a plurality of categories such as fish>bass, stringed-instrument>bass, and men's shoes>bass. Further, the respective topic categories may be sub-topics in one or more larger categories, such as outdoor recreation>sports>fishing>freshwater>fish>bass, arts>music>musical instruments>stringed-instruments>bass, and shopping>clothing>footwear>shoes>men's shoes>bass. The query classifier 142 may use the metadata associated with the matching electronic documents located in the index 130 to classify the query. The metadata that represents the categories associated with the documents can be used to classify the respective query by counting how many times a category is identified as associated with a matching document returned by the index 130.

The answer service 144 may receive the query and classification associated with the query. The answer service 144 detects the social network identifier of the user. For instance, if the user is logged in to a social network account, the social network identifier of the user may be obtained from the social network provider 150. In turn, the answer service 144 may obtain the social network graph for the user from the social network provider 150. The answer service 144 may rewrite the query based on social network profile data of the searcher and friends of the searcher identified in the social network graph. The answer service 144 may add modifiers extracted from the social network profile data to the query with a special search nonretrieval operator, Ω, which specifies different weights for matches on the different modifiers. In one embodiment, the weights of the modifiers from different social network profile fields are obtained by training a machine-learning model on editorially judged data, e.g., judging the best values to assign to profile elements for a specific query, or click log data to return relevant URLs in priority positions of the search engine results page. The weights assigned to the modifiers from different profile fields may vary based on classification of the query. Accordingly, the query classification may be another input into the machine learning model that selects the weights.

The answer service 144 transmits the rewritten query to the index 130. The index 130 receives the rewritten query and identifies entries that match the search terms except the nonretrieval terms. The entries that match the query are returned to the ranking engine 146 to be assigned an order in the search engine results page.

In some embodiments, the answer service 144 may determine whether the query is classified as a name query, and the social network identifier of the user is unavailable. If the query is classified as a name query and the social network identifier is unavailable, the answer service 144 may attempt to identify public social network identifiers associated with the name query. The matching social network identifiers may be utilized to tag entries in the index 130. The answer service 144 submits the name query to the index 130 and receives entries matching the name query. The matching entries are clustered by the answer service 144 based on social network identifiers matching the name query. The clustered entries are transmitted to the ranking engine 146 for ranking.

The ranking engine 146 receives the matching entries from the answer service 144. When the social network identifier is available, the ranking engine 146 orders the entries based on matches between the query or the nonretrieval modifiers and the content items associated with the index entries. The weights assigned to the nonretrieval modifiers determine the increase in priority assigned to a matching entry by the ranking engine 146. The matching nonretrieval modifiers are identified and the weights for each matching nonretrieval modifier are summed, by the ranking engine 146, to calculate the amount by which a rank of the corresponding matching entry is increased.

When the social network identifier is unavailable, in some embodiments, the ranking engine 146 may be configured to order the entries based on the normal ranking function, like PageRank and others, that calculate, among other factors, term frequency within the content, number of in links and out links, and other features of the content, like date, author, last modification, etc to assign a rank score. In other embodiments, when the query is classified as a name query, the ranking engine 146 may cluster the entries based on social network identifier tags included in the index entry and rank the entries within each cluster. The profile data for matching entities to the name query may be used as weighted nonretrieval modifiers that impact the ranking of index entries that match the query and have public social network profile data. The nonretrieval modifiers may be utilize to rank the entries with each of the clusters for the social network identifiers associated with the entities.

Accordingly, the search engine 140 may transmit the query to the index 150. The search engine 140 utilizes the query to identify URLs that match. In turn, the search engine 140 examines the matches and provides the computers 120 a set of uniform resource locators (URLs) that point to web pages, images, videos, or other electronic documents in the search engine results page. The search engine results page may include URLs or clusters of URLs in ranked order based on the classification assigned to the query, the availability of the social network identifier of the searcher, or social network identifiers and profiles for entities identified in the query.

The social network provider 150 receives requests for social network data and generates responses to the requests for social network data. The social network data includes user-profile data, like education, work, current location, hometown, friends, likes, and relationship status. The social network data includes an identifier that corresponds to an entities name. For instance, a social network identifier may be “Bart Smith,” the name of an entity on the social network. The social network information, public or private, may be stored in a database accessible by the social network provider 150. The social network data may also identify the friends of friends for a user and include the data available for the friends of friends. In some embodiments, the social network provider 150 may be a server device that is connected to network 110, index 130, and computer 120.

Accordingly, the computing system 100 is configured with a search engine 140 that provides results that include URLs or clustered URLs. The search query received from the computer 120 is received by the search engine 140, which traverses the index 130 to obtain results, including tagged results based on whether the social network identifier of the searcher is available. The search engine 140 transmits the results to the computer 120. In turn, the computer 120 renders the results for the searchers.

Embodiments of the invention increase the priority of electronic documents matching a query based on social network data available for the searcher or friends of the searcher. The search engine receives a query from a searcher and determines whether a social network identifier is available for the searcher. When the social network identifier of the searcher is not provided by the searcher, the electronic documents are ranked based on the match to the query.

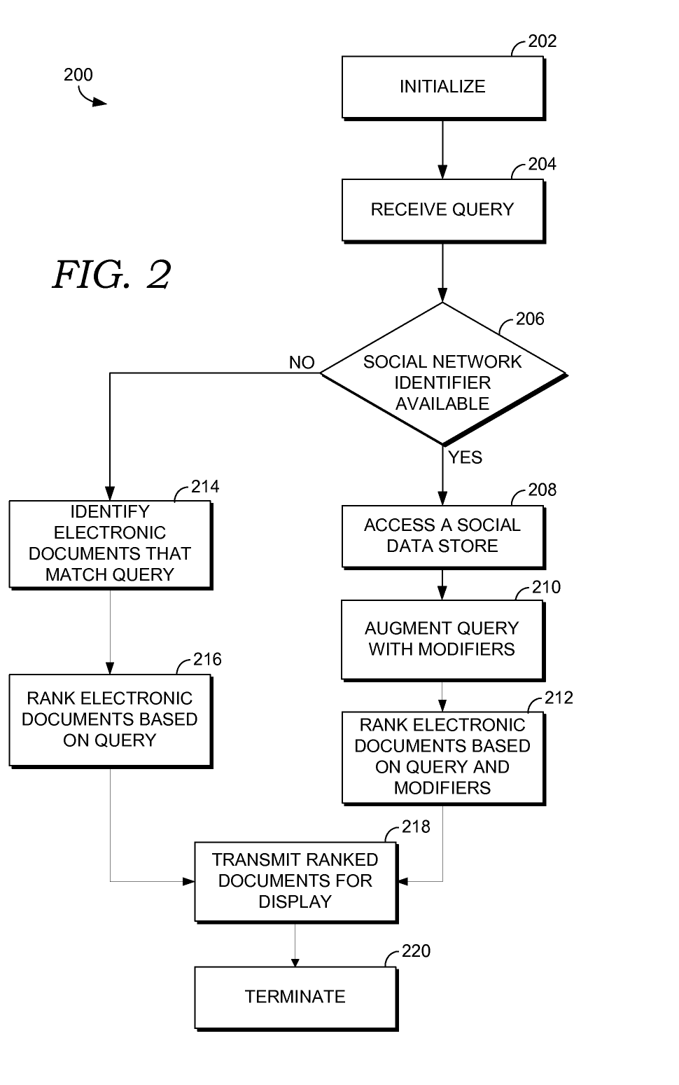

FIG. 2 is a logic diagram illustrating an exemplary computer-implemented method for ranking electronic documents provided in a search engine results page, in accordance with embodiments of the invention. The method initializes in step 202. In step 204, the search engine receives a query from a searcher. In step 206, the search engine determines whether a social network identifier is available for the user.

When the social network identifier is available, obtaining, by the search engine, from a social data store a social network graph of the searcher, in step 208. In turn, augmenting the query with weighted nonretrieval modifiers based on profile data obtained from the social network graph, in step 210. In at least one embodiment, the profile data includes items that the user likes. The profile data may also include any of the following: location, name, relationship status, hometown, education, and employment for the searcher and friends of the searcher.

In some embodiments, the search engine classifies the query and assigns weights to the weighted nonretrieval modifiers based on a classification associated with the query. The weights assigned to the weighted nonretrieval modifiers may vary based on the classification of the query. For instance, if the query is classified as a sports query, hometown and current location fields may be assigned the higher weights, by the search engine, than if the query is classified as a finance query, where work and education may be assigned the higher weights instead of the hometown and current location fields. In certain embodiments, the classification of the query may be one or more of: person, business, politics, sports, finance, movies, food, entertainment, directions, or general. The search engine ranks electronic documents that match the query based on the search terms included in the query and the weighted nonretrieval modifiers, in step 212. In at least one embodiment, a score that is a sum of each of the weighted nonretrieval modifiers corresponding to matching profile data is generated by the search engine to increase the rank of the electronic documents that match the available social network data of the searcher and friends of the searcher.

When the social network identifier is unavailable, identifying, by the search engine, electronic documents that match the query, in step 214. In turn, the search engine ranks the electronic documents that mate the query based on the search terms included in the query, in step 216. The search engine transmits the ranked documents to the user for display on a computing device, in step 218. The method terminates in step 220.

Accordingly, if the search engine classifies a query as a name query, the search engine accesses the social network graph stored by the social network provider to find friends and friends-of-friends of the searcher whose names match the query. The query is then augmented by the search engine with Ω-terms obtained from (a) profile information of the searcher, (b) profile information of the matching friend, (c) profile information of the matching friend-of-friend, and (d) the profile information of mutual friends of the searcher and the matching friend or matching friend-of-friend. The search engine assigns weights for these Ω-terms and utilizes the Ω-terms for ranking of matching electronic documents.

For instance, a searcher generated a query for “Sam Lee,” intending to look for the “Sam Lee” who is a Professor of Computer Science at State University and part of the searcher's social network. However, the search engine results page include URLs about another “Sam Lee.” If, however, the search engine knows that on the social network of the searcher, the searcher is two hops away from the “Sam Lee” who is a Professor of Computer Science at State University. The search engine may utilize the Ω-terms of the searcher and Professor to prioritize URLs for the Sam Lee that is one the searcher's social network and the one the searcher is most likely searching for. The search engine may augment the query with Ω-terms that boost the rank of electronic documents corresponding to the most likely Sam Lee. The new query generated by the search engine may be “Sam Lee Ω(Professor, 10) Ω(State University, 100) Ω(computer science, 50)” where the terms “Professor,” “Berkeley,” and “computer science” were extracted from the social network profile of the Sam Lee who is a friend-of-friend of the searcher. Ω-operators simply affect ranking, without affecting the retrieved set of matching documents, i.e., documents about the other Sam Lee, would still be returned but would not receive the ranking boost given to documents about the Professor “Sam Lee.”

In alternate embodiments of the invention, an index tagged with social network identifiers may be accessed to cluster electronic documents matching a query based on social network identifiers that match the query, when the search engine classifies the query as a name query. The search engine receives a query from a searcher and determines whether a social network identifier is available for the searcher. When the social network identifier of the searcher is not provided by the searcher, the electronic documents are ranked within clusters based on the match to the query.

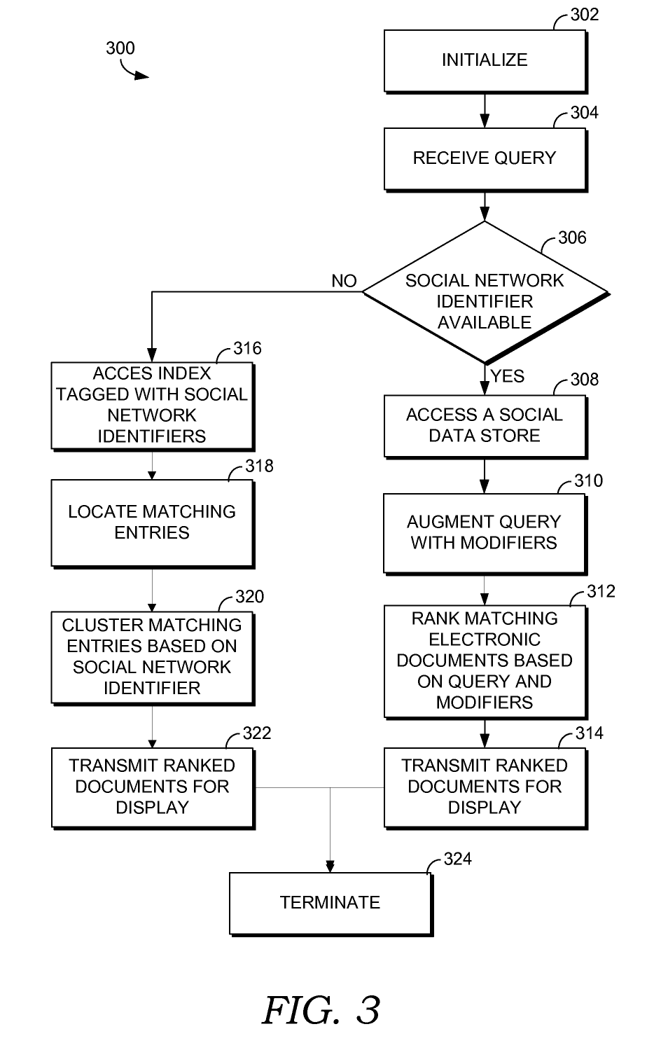

FIG. 3 is a logic diagram illustrating another exemplary method for ranking electronic documents provided in a search engine results page, in accordance with embodiments of the invention. The method initializes in step 302. The search engine receives a query, in step 304. In step 306, the search engine determines whether a social network identifier is available for the user. When the social network identifier is available, the search engine obtains from a social data store a social network graph of the searcher, in step 308. In step 310, the search engine augments the query with weighted nonretrieval modifiers based on profile data obtained from the social network graph. In one embodiment, the profile data includes items that the searcher likes. The profile data may also include any of the following: location, name, relationship status, hometown, education, and employment, etc., associated with the searcher or the friends of the searcher.

In certain embodiments, the search engine classifies the query. In turn, weights are assigned to the weighted nonretrieval modifiers based on a classification associated with the query by the search engine. The weights assigned to the weighted nonretrieval modifiers vary based on the classification of the query. The classification of the query is one or more of: person, business, sport, finance, movie, food, entertainment, directions, or general. The search engine ranks electronic entries corresponding to documents that match the query based on the search terms included in the query and the weighted nonretrieval modifiers, in step 312. In step 314, the search engine transmits the ranked electronic entries to the user for display on a computing device of the searcher. The search engine may generate a score that is a sum for each of the weighted nonretrieval modifiers corresponding to profile data matching content of the electronic entries to improve the rank of a subset of matching electronic documents that match the social network data for searcher and friends of the searcher.

When the social network identifier is unavailable, the search engine accesses an index tagged with social network identifiers for a plurality of entities, in step 316. In step 318, the search engine determines whether the query matches any of the electronic entries included in the index and locates the matching electronic entries, in turn, the search engine clusters the matching electronic entries based on the social network identifiers, in step 320. In step 322, the search engine transmits the results and the clustered electronic entries to the user for display on the computing device. The method terminates in step 324.

Thus, when the he social network identity of the searcher is not known to the search engine, the results included in the search engine results can still be improved in the case of ambiguous name queries, i.e., where two or more entities share same name and have web presences. Every electronic index entry that contains one or more names is pre-tagged with the social network identifiers of users with the same names who best match the document associated with the electronic index entries. The strength of a match of a document to a user with the same name may be computed as a weighted sum of matches on different profile fields such as work place, school, hobbies, etc available in the social network data of the entities. In some embodiments, weights on different profile fields are utilized to determine the strength of the matches. If there is no user who has a stronger match on the document than other users with the same name, the document may not be tagged with any of their IDs. In other embodiments, each documents is tagged with a social network identifier, and the strength of matching profile data is reflected in the order of the clusters included in the search engine results page. When a query is received by the search engine, it is classified. If the query is a name query, the search engine may access a public social data store to determine the social network identifiers of entities that match the name query. The query together with the public social network identifiers of entities are transmitted to the index, which returns all electronic index entries that match the name query together with their public social network identifiers. The search engine receives the matching entries and clusters them based on the matching social network identifiers. The entries within each cluster are ranked based on matches to the query. In other embodiments, the entries may be ranked based on the similarity between the content associated with the entries and the profile data associated with the entities with the same name. The clusters are returned by the search engine to the searcher as alternative result sets that the searcher can drill down into.

For instance, there may be at least two Sam Lee's located in the public social network. One who is a Professor of Computer Science at State University, specializing in computer science, and the other who is an analyst at a bank in New York. When the searcher is anonymous and submits a query for “Sam Lee,” the search engine may respond to the searcher with two or three clustered result sets based on public social network information available for each entity with the name Sam Lee. The first cluster may contain electronic documents about Sam Lee that also contain the terms “State University” or “Professor” or “computer science.” The second cluster may contain electronic documents about Sam Lee that also contain the terms “bank” or “banker” or “New York.” The third cluster may include electronic documents associated with an entity “Sam Lee” that does not match the terms for social network profiles associated with the other two clustered entities. This would enable the searcher to quickly drill down into the cluster he or she is most interested in.

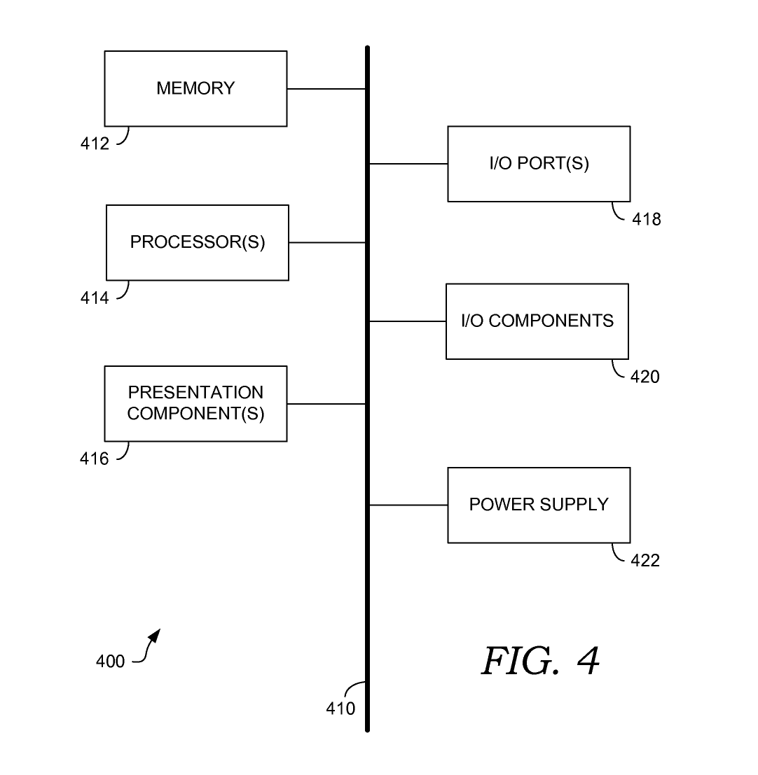

FIG. 4 is a component diagram illustrating an exemplary operating environment. Having briefly described an overview of the embodiments of the invention, an exemplary operating environment in which various aspects of the invention may be implemented is now described. Referring to the drawings generally, and initially to FIG. 4 in particular, an exemplary operating environment for implementing embodiments of the invention is shown and designated generally as computing device 400. Computing device 400 is but one example of a suitable computing environment and is not intended to suggest any limitation as to the scope of use or functionality of the invention. Neither should the computing device 400 be interpreted as having any dependency or requirement relating to any one or combination of components illustrated.

The embodiments of the invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The embodiments of the invention may also be practiced in distributed computing environments where tasks are performed by remote-processing devices that are linked through a communications network.

With continued reference to FIG. 4, computing device 400 includes a bus 410 that directly or indirectly couples the following devices: memory 412, one or more processors 414, one or more presentation components 416, input/output ports 418, input/output components 420, and an illustrative power supply 422. Bus 410 represents what may be one or more busses (such as an address bus, data bus, or combination thereof). Although the various blocks of FIG. 4 are shown with lines for the sake of clarity, in reality, delineating various components is not so clear, and metaphorically, the lines would more accurately be grey and fuzzy. For example, one may consider a presentation component such as a display device to be an I/O component. Additionally, many processors have memory. The inventor hereof recognizes that such is the nature of the art, and reiterates that the diagram of FIG. 4 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 4 and reference to “computing device.”

Computing device 400 typically includes a variety of computer-readable media. Computer-readable media can be any available media that can be accessed by computing device 400 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, Random Access Memory (RAM), Read Only Memory (ROM), Electronically Erasable Programmable Read Only Memory (EEPROM), flash memory or other memory technology, CD-ROM, digital versatile disks (DVD) or other holographic memory, magnetic cassettes, magnetic tape, magnetic disk storage or other magnetic storage devices, carrier wave, or any other medium that can be used to encode desired information and which can be accessed by the computing device 100.

Memory 412 includes computer-storage media in the form of volatile and/or nonvolatile memory. The memory may be removable, nonremovable, or a combination thereof. Exemplary hardware devices include solid-state memory, hard drives, optical-disc drives, etc. Computing device 400 includes one or more processors that read data from various entities such as the memory 412 or the I/O components 420. The presentation component(s) 416 present data indications to a user or other device. Exemplary presentation components include a display device, speaker, printing component, vibrating component, etc.

I/O ports 418 allow the computing device 400 to be logically coupled to other devices including the I/O components 420, some of which may be built in. Illustrative components include a microphone, joystick, game pad, satellite dish, scanner, printer, wireless device, etc.

Embodiments of the present invention work to best exploit the information that can be found on a social networking site to reliably have individuals who have a pre-defined type of relationship with a searcher, influence the search results and/or advertisements presented to the searcher. The search engine augments a query with nonretrieval modifiers based on the social network information of the searcher. The matching entries of the query are ordered to place additional priority on entries that match both the query and the social network information.

For instance, a search engine may receive a name query for a searcher logged in to a social network. The search engine accesses the social network of the searcher and looks for friends or friends-of-friends of the searcher whose name matches the query. If multiple entities have the same name, then it is likely that the searcher is looking for the particular entity that is the fewest hops away from him/her in the social network. The search engine then rewrites the query with social terms obtained from the profile information of the matching friends or friends-of-friends. This includes the profile information of the mutual friends of the searcher and the matching friends or friends-of-friends having a name that matches the name query. It is likely that electronic documents that contain the names of mutual friends are of interest to the searcher; so, the search engine attempts to impact the order of the electronic documents. The weight is specified for matches on each of the added social terms, e.g., matches on mutual friends, or the number of mutual friends, may be given a lower weight than matches on work place shared by the friend or friend-of-friend and the searcher. These different weights may be obtained from a machine-learning model and utilized to rank the electronic documents retrieved from the index by the search engine.

The embodiments of the invention have been described in relation to particular embodiments, which are intended in all respects to be illustrative rather than restrictive. Alternative embodiments will become apparent to those of ordinary skill in the art to which the present invention pertains without departing from its scope. From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and subcombinations. This is contemplated by and is within the scope of the claims.

1. A computer-implemented method to rank electronic documents provided in a search engine result page, the method comprising:
receiving, by one or more computing devices, a query from a user;
determining, by the one or more computing devices, whether a social network identifier is available for the user;
when the social network identifier is available, performing, by the one or more computing devices, the following:
obtaining a social network graph of the user,
augmenting the query with weighted nonretrieval modifiers based on profile data obtained from the social network graph,
ranking electronic documents that match the query based on the search terms included in the query and the nonretrieval modifiers, and
transmitting the ranked documents to the user for display on a computing device; and
when the social network identifier is unavailable, performing, by the one or more computing devices, the following:
identifying electronic documents that match the query based on the search terms included in the query,
ranking electronic documents that match the query based on the search terms included in the query, and
transmitting the ranked documents to the user for display on a computing device.

2. The computer-implemented method of claim 1, further comprising: classifying the query.

3. The computer-implemented method of claim 2, further comprising: assigning weights to the weighted nonretrieval modifiers based on a classification associated with the query.

4. The computer-implemented method of claim 3, wherein the weights assigned to the weighted nonretrieval modifiers vary based on the classification of the query.

5. The computer-implemented method of claim 4, wherein the classification of the query is one or more of: person, business, politics, sports, finance, movies, food, entertainment, directions, or general.

6. The computer-implemented method of claim 1, wherein the profile data includes items that the user likes.

7. The computer-implemented method of claim 1, wherein the profile data includes any of the following: location, name, relationship status, hometown, education, and employment.

8. The computer-implemented method of claim 1, wherein ranking the electronic documents that match the query based on the search terms included in the query and the nonretrieval modifiers further comprises: generating a score that is a sum of each of the weighted nonretrieval modifiers corresponding to matching profile data.

9. One or more memories having computer-executable instructions embodied thereon for performing a method to rank electronic index entries, the method comprising:
receiving, by one or more computing devices, a query from a user;
determining, by the one or more computing devices, whether a social network identifier is available for the user;
when the social network identifier is available, performing, by the one or more computing devices, the following:
obtaining a social network graph of the user,
augmenting the query with weighted nonretrieval modifiers based on profile data obtained from the social network graph,
ranking electronic index entries that correspond to documents that match the query based on the search terms included in the query and the nonretrieval modifiers, and
transmitting the ranked electronic entries to the user for display on a computing device; and
when the social network identifier is unavailable, performing, by the one or more computing devices, the following:
accessing an index tagged with social network identifiers for a plurality of entities,
determining whether the query matches any of the electronic entries included in the index,
clustering matching electronic entries based on the social network identifiers,
transmitting the results and the clustered electronic entries to the user for display on the computing device.

10. The memories of claim 9, further comprising:
classifying the query.

11. The memories of claim 10, further comprising: assigning weights to the weighted nonretrieval modifiers based on a classification associated with the query.

12. The memories of claim 11, wherein the weights assigned to the weighted nonretrieval modifiers vary based on the classification of the query.

13. The memories of claim 12, wherein the classification of the query is one or more of: person, business, sport, finance, movie, food, entertainment, directions, or general.

14. The memories of claim 9, wherein the profile data includes items that the user likes.

15. The memories of claim 9, wherein the profile data includes any of the following: location, name, relationship status, hometown, education, and employment.

16. The memories of claim 9, wherein ranking the electronic entries that match the query based on the search terms included in the query and the nonretrieval modifiers further comprises: generating a score that is a sum for each of the weighted nonretrieval modifiers corresponding to profile data matching content of the electronic entries.

17. A computer system that executes a search engine configured to rank electronic index entries, the system comprising:
an index of electronic entries for multimedia data; and
one or more processors configured to receive a query from a user, to determine whether a social network identifier is available for the user, when the social network identifier is available, to obtain a social network graph for the user, to augment the query with weighted nonretrieval modifiers based on profile data obtained from the social network graph, to rank electronic index entries that match the query based on the search terms included in the query and the nonretrieval modifiers, and to transmit the ranked index entries to the user for display on a computing device.

18. The system of claim 17, wherein the one or more processors are configured to tag the index with social network identifiers for a plurality of entities, to access the index tagged with social network identifiers for the plurality of entities, to determine whether the query matches any of the electronic entries included in the tagged index, to cluster matching electronic entries based on the social network identifiers, and to transmit the results and the clustered electronic entities to the user for display on the computing device.

19. The system of claim 17, wherein the one or more processors are configured to classify the query.

20. The system of claim 19, wherein the one or more processors are configured to assign weights to the weighted nonretrieval modifiers based on a classification associated with the query.
